(19) United States
(12) Patent Application Publication
(10) Pub. No.: US 2020/0064841 A1
(43) Pub. Date: Feb. 27, 2020

(54) MODULAR AUTONOMOUS PLATFORM

(71) Applicant: Perrone Robotics, Inc., Crozet, VA (US)

(72) Inventor: Paul J. PERRONE, Crozet, VA (US)

(21) Appl. No.: 16/539,191

(22) Filed: Aug. 13, 2019

Related U.S. Application Data
(60) Provisional application No. 62/765,330, filed on Aug. 22, 2018.

(51) Int. Cl. G05D 1/00

(52) U.S. Cl. CPC G05D 1/0088; G05D 2201/0216

(57) ABSTRACT

A general-purpose robotics platform that can be modularly inter-connected with other platforms to create composite platforms capable of carrying larger payloads, performing more tasks, and travelling longer distances. The modular platforms can carry different payloads to service different robotics applications. A modular autonomous platform includes a mobility module and a base module. The mobility module includes a drive system and is configured to move the modular autonomous platform. The base module is attached to the mobility module and includes an interface configured to receive a payload and an interface configured to couple with another modular autonomous platform.

### CROSS-REFERENCE TO RELATED APPLICATION

This application claims priority to U.S. Provisional Application No. 62/765,330, filed on Aug. 22, 2018.

### FIELD OF INVENTION

The present invention generally relates to mobile autonomous robotics and autonomous mobile platforms. In aspects, the invention relates to a general-purpose robotics platform that can be modularly inter-connected with other platforms to create composite platforms capable of carrying larger payloads, performing more tasks, and travelling longer distances. The modular platforms can carry different payloads to service different robotics applications. The invention generally applies to such platforms operating in ground-based robotics mobile platforms. The platforms can carry people and things and serve applications such as autonomous people shuttles, autonomous mobility of things (e.g. luggage, equipment, and goods), and assemblage into larger composite mobilization platforms for people and things. However, different underlying mobility mechanisms will also enable the platforms to operate on the ground, in the air, on water or underwater, or in space.

### BACKGROUND

Specialized mobile robots exist today that operate both indoors and outdoors. Smaller ground-based robots providing different services and performing different functions exist, such as vacuum cleaners, agriculture robots, security patrol robots, food delivery robots, and autonomous forklifts (FIG. 1). Furthermore, driverless cars and vehicles that carry people also exist today, in prototype form and otherwise. Autonomous vehicles such as shuttles to carry people at low speeds in controlled environments and autonomous passenger vehicles carrying people at higher speeds in open public environments exist (FIG. 2). These mobile autonomous robotic applications offer specific robotic designs tailored for single-task or narrowly-focused robotic applications. For example, robotic vacuum cleaners are designed specifically with single-purpose robotic functions to vacuum floors indoors. These robots differ in design and function from food delivery robots traversing sidewalks outdoors. Those robots, in turn, differ in design and function from autonomous shuttles carrying people in controlled environments.

### BRIEF SUMMARY

The present invention generally relates to a series of general-purpose robotics platforms that can carry different types of payloads for more specific applications and perform different functions depending on how they are configured. Configuration consists of different mechanical and electrical components to support movement and transport of items, as well as software configurations needed to perform different tasks. That is, the platform is designed to provide mobile autonomous robotic functions independent of the payloads attached to the platform. Payload examples include, without limitation, a seat to carry a person, multiple seats to carry multiple people, a container to carry luggage, a basket to carry bulk goods, a wheel barrow to carry dirt, shelving to carry food and drinks, a container to carry trashcans, or a shopping cart basket. FIG. 3 shows some example payloads for existing non-robotic mobility platforms.

### BRIEF DESCRIPTION OF THE DRAWINGS/FIGURES

FIG. 1—Specialized Ground Robots

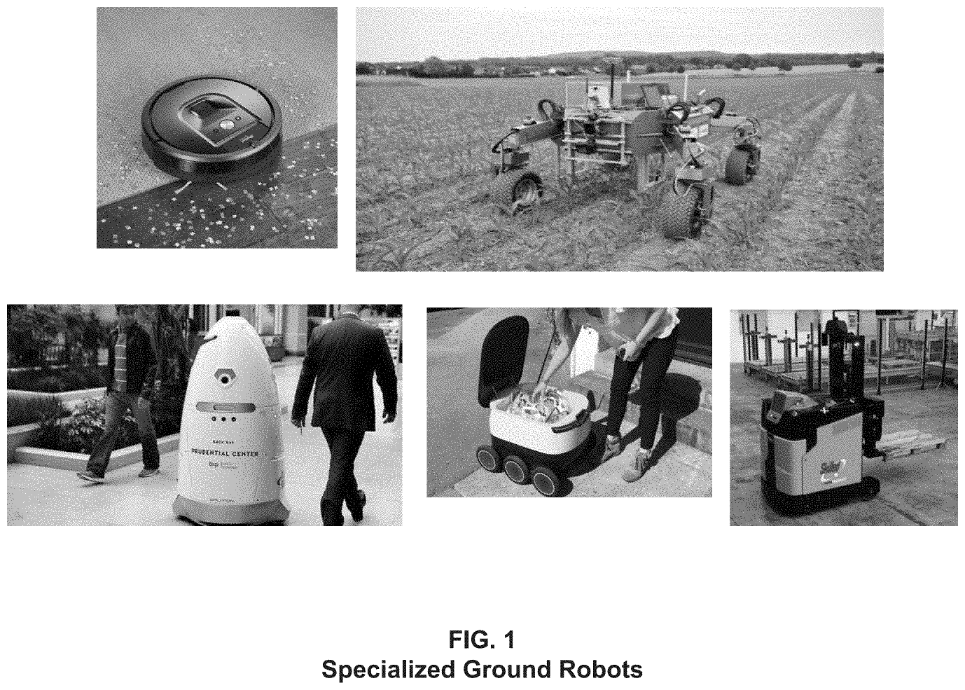

FIG. 2—Autonomous Shuttles and Passenger Vehicles

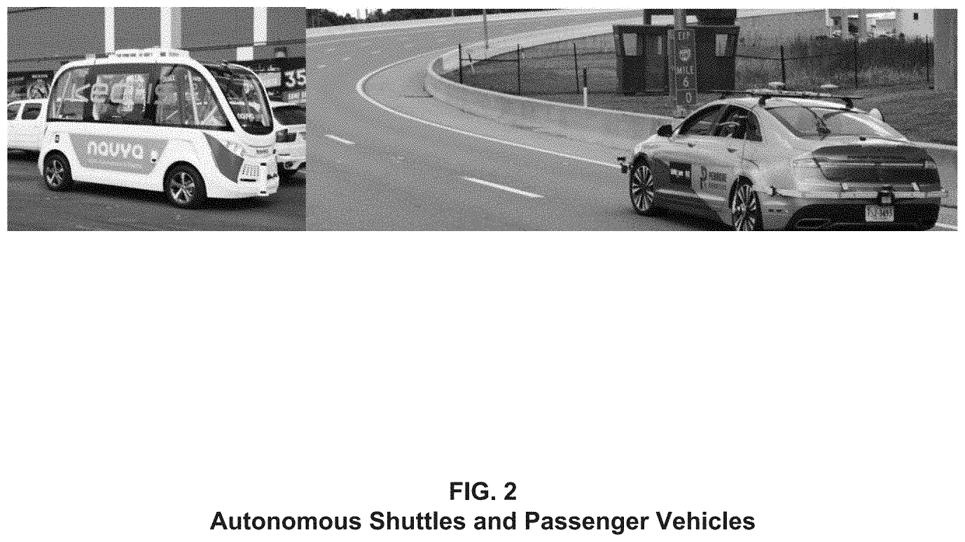

FIG. 3—Payload Examples for Non-Robotic Mobility Platforms

FIG. 4—Separation of base module from underlying mobility module

FIG. 5—Example underlying ground-based mobility modules

FIG. 6—Example underlying mobility modules for air, surface-water, and underwater applications

FIG. 7—Scalable sizing

FIG. 8—Longitudinally and physically connected MAP examples (view from overhead)

FIG. 9—Laterally and physically connected MAP examples (view from overhead, direction of travel indicated by arrow)

FIG. 10—Lateral and longitudinal combination of MAP examples (view from overhead; direction of travel indicated by arrow)

FIG. 11—Wirelessly connected and coordinated MAP examples (view from overhead, direction of travel indicated by arrow)

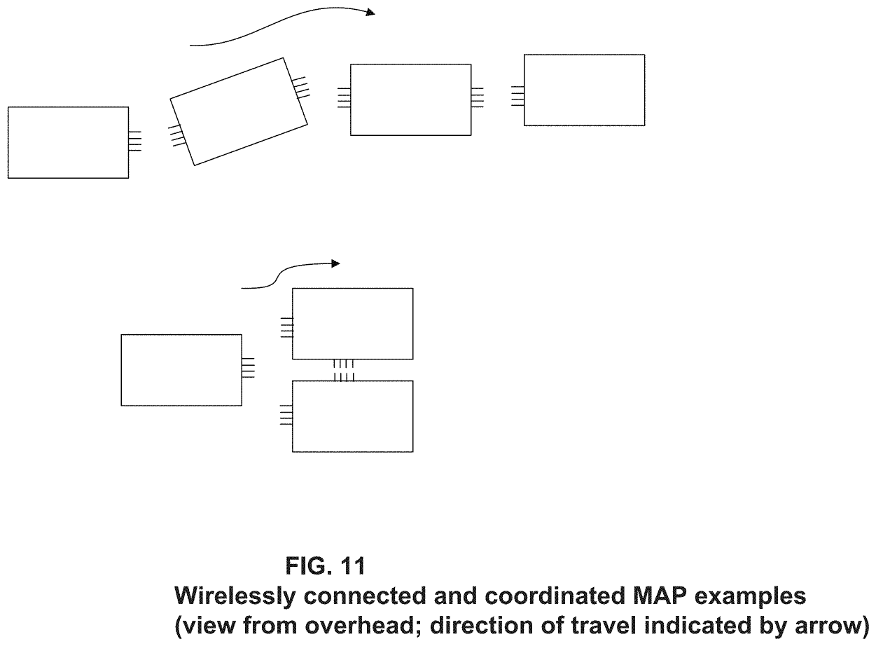

FIG. 12—MAP structural component example

FIG. 13—Side and top view of base module example configuration

### DETAILED DESCRIPTION

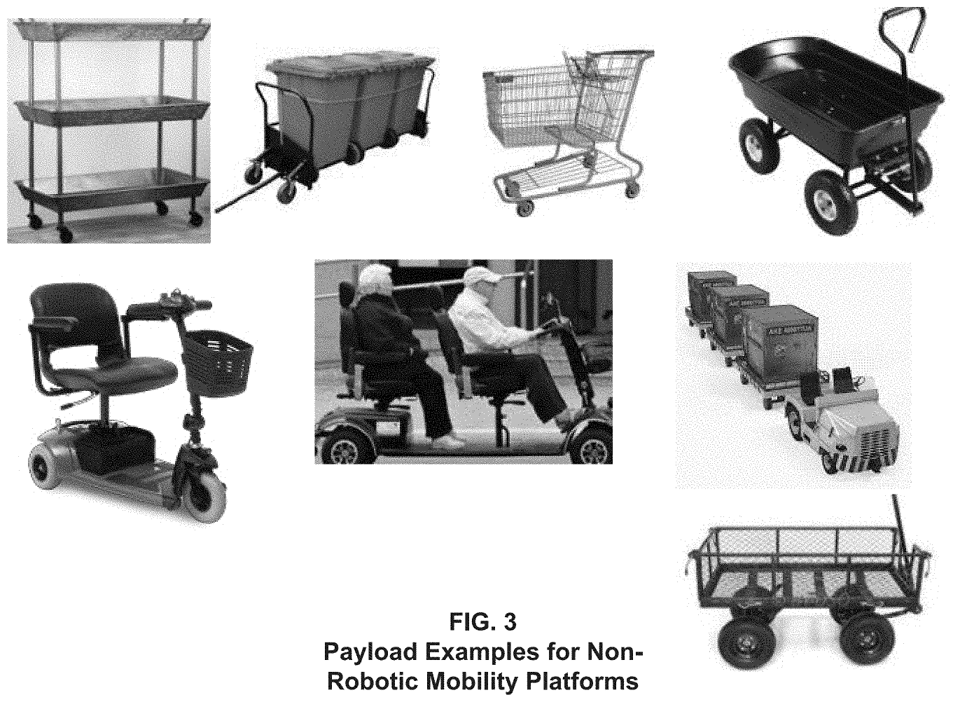

The present invention generally relates to a series of general-purpose robotics platforms that can carry different types of payloads for more specific applications and perform different functions depending on how they are configured. Configuration consists of different mechanical and electrical components to support movement and transport of items, as well as software configurations needed to perform different tasks. That is, the platform is designed to provide mobile autonomous robotic functions independent of the payloads attached to the platform. Payload examples include, without limitation, a seat to carry a person, multiple seats to carry multiple people, a container to carry luggage, a basket to carry bulk goods, a wheel barrow to carry dirt, shelving to carry food and drinks, a container to carry trashcans, or a shopping cart basket. FIG. 3 shows some example payloads for existing non-robotic mobility platforms.

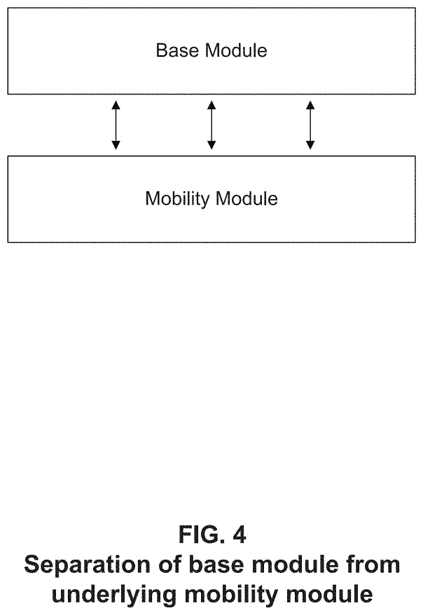

A series of standard mechanisms for attaching different structures for carrying different payloads is defined in the invention. This singular mobile autonomous platform module capable of carrying different payloads is referred to throughout this application as a Modular Autonomous Platform “MAP”. The MAP can have different underlying ground-based mobilization methods (mobility modules) attached to a base module (FIG. 4).

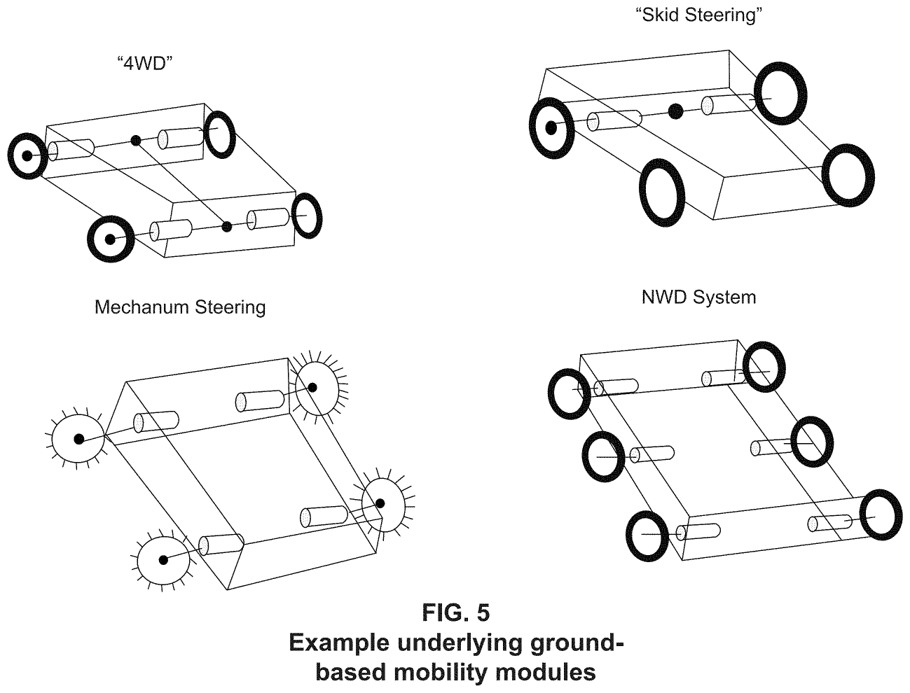

Whether four-wheel drive, two-wheel drive skid-steering, holonomic or mechanum wheel-based multi-directional mobility, or multiple-wheel drive systems, the MAP is designed to be electrically and mechanically interchangeable with different underlying mobilization methods (FIG. 5).

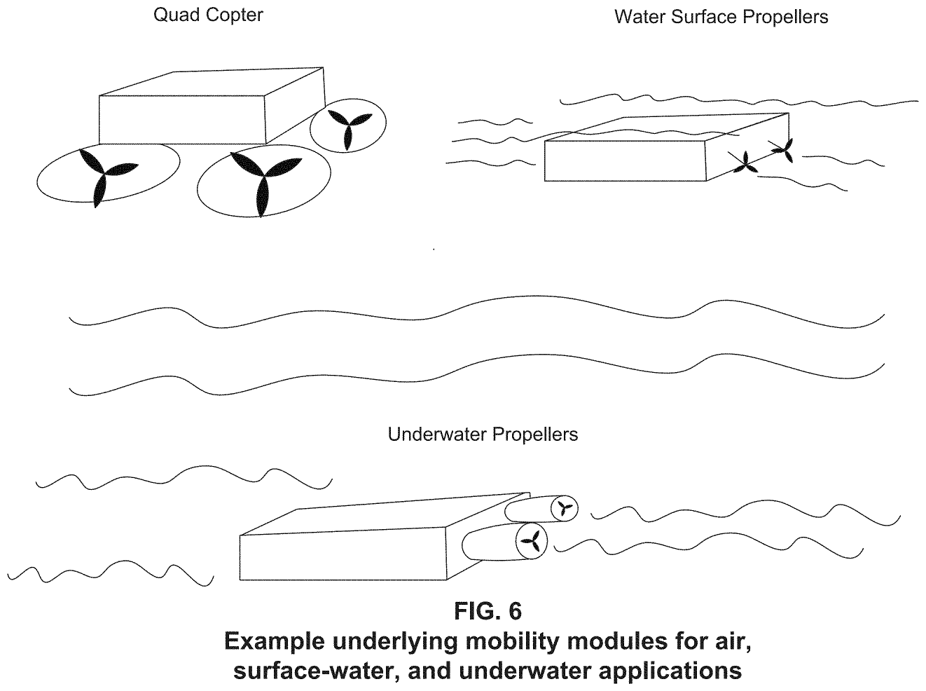

Further extensions to the invention apply to MAPs that may also contain mobility mechanisms for airborne flight (e.g. drone-like propellers), for water-borne travel (e.g. water propellers), for underwater travel (e.g. underwater propellers) (FIG. 6), or for travel in space (e.g. reactive propulsion using chemical, liquid fuels or compressed gasses). The MAP control software similarly adapts to the mobilization method chosen through direct or semi-automatic configuration changes triggered by the installation of the mobilization method.

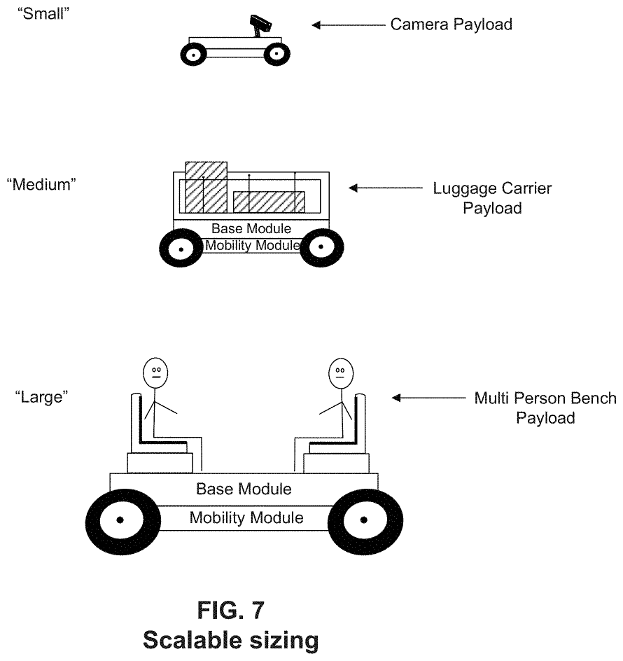

The MAPs are constructed to scale in scope to support a wide range of applications. The same MAP structure may be used as a small-scale platform that can carry only small payloads (e.g. cameras for security), or combined to form mid-size platforms that can carry larger payloads (e.g. a human being or some luggage), or further combined to form large-size platforms that can carry even larger payloads (e.g. multiple people), and so on (FIG. 7).

The MAP control software orchestrates the movements of the base and mobility module and the individual MAP hardware platforms to facilitate unified and coordinated movement and behavior.

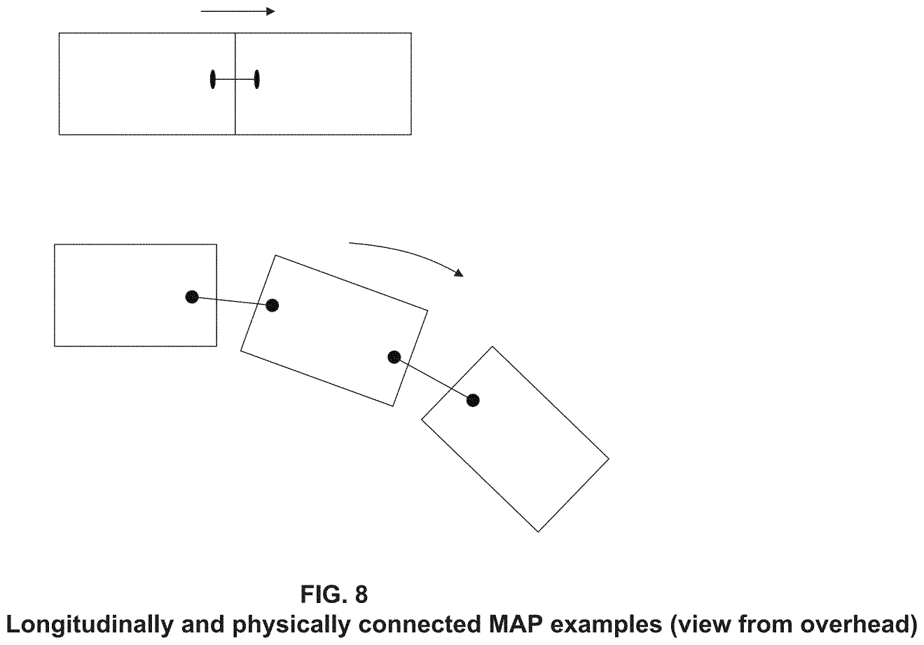

The invention also includes a means to physically connect multiple MAPs in a longitudinal chain along their direction of travel to form longer MAP chains (e.g. for carrying luggage akin to airport luggage carriers) (FIG. 8).

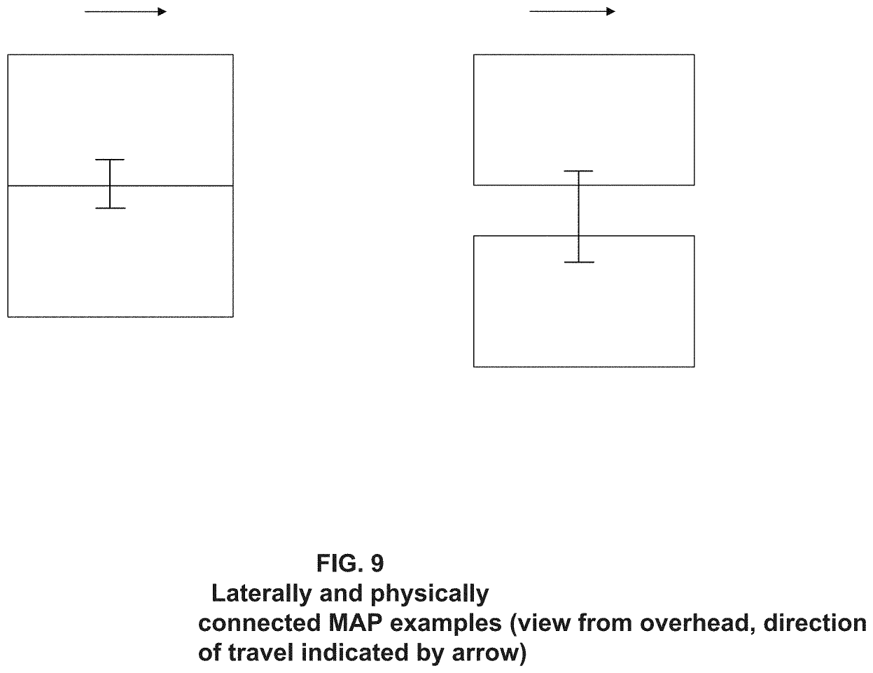

The invention further includes a means to physically connect MAPs laterally with each other for wider payload capacity (e.g. two MAPs connected side-by-side to carry two people) (FIG. 9).

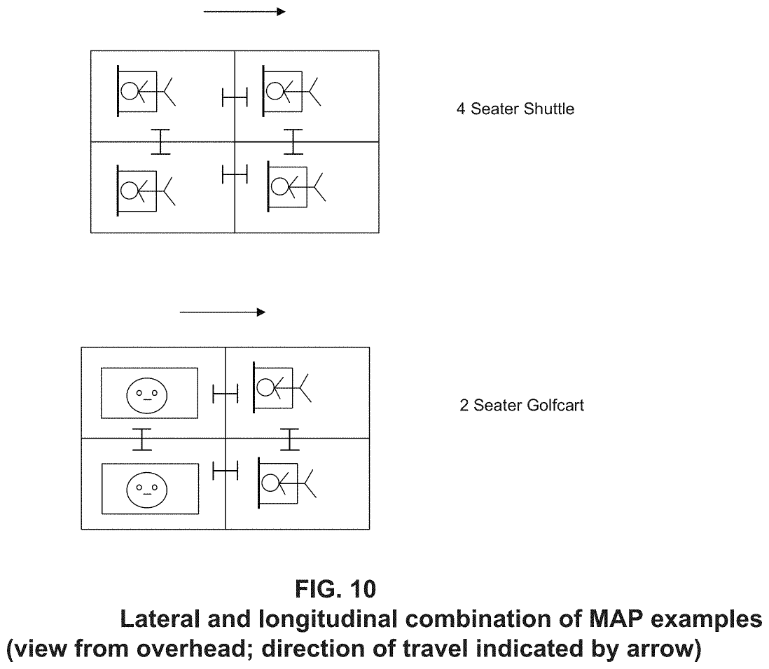

Thus, by longitudinal or lateral connection, as an example, four MAPs, each of which can carry one person, may be assembled to form a four-seater autonomous shuttle application. Alternately, two MAPs laterally connected to carry two people, coupled with two more laterally connected MAPs with containers to carry golf bags and longitudinally connected, may be assembled to form an autonomous golf cart. By combination of discrete MAPs, a wide variety of autonomous robotic mobility applications may be achieved. (FIG. 10)

Furthermore, the invention includes a means for MAPs to wirelessly communicate with one another to form coordinated wireless convoys of MAPs. Such wireless operation is specified to create distance offsets from one another longitudinally, laterally, or by some other offset, such that MAPs can travel in unison with one another. These distance offsets may be fixed or dynamically adjusted via configuration. This method allows for dynamic assembly of MAPs in a wireless fashion coordinated to carry payloads together to a common destination. For example, two MAPs, each carrying a person, may wirelessly coordinate to travel side-by-side and further wirelessly communicate and coordinate with two other MAPs, each carrying luggage, traveling behind the people-carrying MAPs for a shuttle application at an airport.

A MAP can operate singularly carrying its attached payload. Payload attachments may include, without limitation, a chair or bench for a person, a basket for groceries or other goods, shelving for plates and drinks, piping to contain trash cans, buckets for dirt, containers for luggage, and other payload attachment mechanisms which are adapted like “cartridges” to plug into the underlying MAP.

MAPs may be connected physically or wirelessly to form composite MAPs. MAPs may operate indoors and/or outdoors. MAPs are designed to scale for a variety of physical sizes.

The MAPs thus address a novel need not fulfilled by the current state of the art. Rather than design for specialized applications, the MAPs provide a common platform to service a wide variety of mobile autonomous robotic applications. MAPs, with vacuum cleaning payload attachments serve as robotic vacuum cleaners. MAPs with farming payload attachments serve as agriculture robots operating outdoors. Small MAPs with camera payloads serve as security patrol robots. MAPs with baskets serve as food delivery robots. Larger MAPs with forklift attachment payloads serve as autonomous forklifts. MAPs with chairs and benches as payloads serve as autonomous shuttles or carts. Thus, various mobile autonomous robotic applications are serviced by one common mobile autonomous robotic platform design with payload attachments for specific robotic applications.

Structural Aspects

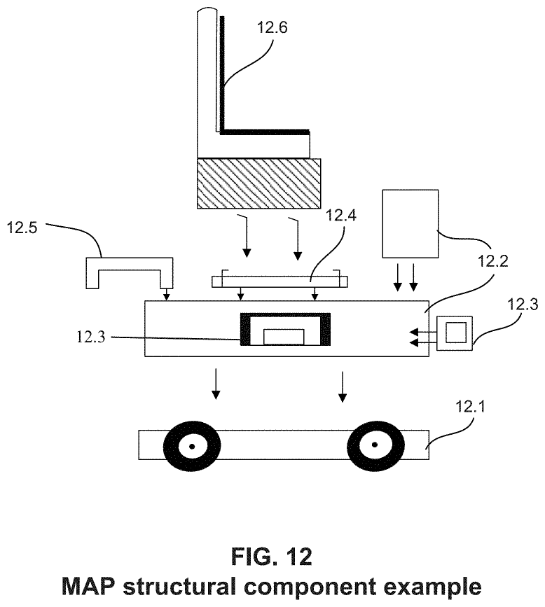

An individual MAP may consist of discrete modules which are assembled according to the needs of a particular class of mobile robotics applications. These modules are connectable electrically and mechanically, and are also controlled by a similarly modular control software. These discrete modules (shown in FIG. 12) include 1) a mobility module (12.1), 2) a plurality of base modules (12.2), 3) a plurality of electronics equipment modules (12.3), 4) a plurality of payload cartridge interface modules (12.4), 5) optionally, a plurality of inter-MAP interface modules (12.5), and 6) the control software that adapts the overall behavior of the integrated system. The payloads for differing applications (12.6 shows an example chair payload) interface with the MAP via a payload cartridge interface module (12.4).

At its foundation, the mobility module dictates the underlying mechanisms by which the platform is mobilized to induce movement of some sort. The mobilization module can be ground based, air-based, underwater-based, water surface-based, or space based.

A mobility module contains a mobilizer (e.g., a wheel, individual leg, propeller, jet, etc.), an actuation mechanism, and mechanical linkages and gears between the mobilizer and the actuation mechanism source. A mobility mechanism embodies mechanical linkages and permits configuration of such linkages in a variety of ways suitable for the environment (air, land, water, or space). In such a fashion, a completely generic means for creating any type of mobility mechanism is provided in a configurable fashion. The actuation mechanism that drives the mobilizer through some mechanical linkage may be directly connected to the mobilizer or it may be indirectly connected via some mechanical linkage such as a differential gear train. A mobility module is configured with one or more mobility mechanisms.

The mobility module may be generically configured for specific mobility types. As an example, there is exists a mobility wheeled module for application to wheeled type mobility of any sort. A wheeled mobility module, wheel mechanism, and wheel are specific types of components for use with the mobility module. Each wheel mechanism may be configured to connect to a wheel and corresponding actuator which happens to directly drive the wheel. Alternately, a wheel mechanism may be configured to reference a shared actuator which drives multiple wheels through a shared differential gear train. Any sort of wheeled configuration can be achieved.

Likewise, a legged mobility module, legged mechanism, and leg components can exist in a mobility legged configuration. Likewise, a tracked mobility module, tracked mechanism (with wheels or other mechanism that move the tracks), and track components can exist in a mobility tracked configuration.

The mobility module is not limited to ground-based robots and vehicles. The mobility module service may be configured to provide mobility for land, air, sea, underwater, space, and other approaches (such as underground tunnels or tracks) for providing mobility. As an example, a flight mobility module and flight mechanism provide one type of base aeronautical mobility configuration. These components are further specialized into a helicopter mobility platform and helicopter mechanism for helicopter applications. These components may also be further specialized into a quad-copter mobility platform and quad-copter mechanism for quad-copter applications.

A ground-based mobility module has associated control software configured for specific services localized to manned or unmanned ground vehicles (UGV). A UGV includes both teleoperated and autonomous ground vehicles. This implementation further specializes the mobility module by configuring specific types of mobility controls software, including drive control modules, throttle control modules, steering control modules, direction control modules, gear control modules, emergency brake (E-brake) control modules, fail-safe control modules, speed control modules, and a collection of other pluggable software control modules.

A drive software control module encapsulates the overall command and control of a UGV. The drive speed of a UGV is thus dictated through a drive control module. A steering control module encapsulates control of the steering of a UGV. The steering direction or angle of a UGV is thus dictated through a steering control module. A brake control module encapsulates control of the braking of a UGV. The braking of a UGV is thus dictated through a brake control module. It should be noted that by commanding the drive control module to a speed of zero may also result in the braking of a UGV, as determined by the overall movement control software. A direction control module encapsulates control of the direction of a UGV. The forward, reverse, or alternate directional state of a UGV is thus dictated through a direction control module. By commanding the steering control of a UGV, its direction may also be impacted. A gear control module encapsulates control of the gearing for the drive system of a UGV. A gear control module thus may include gears for states such as low, high, park, and neutral, the different states for which are configurable by this module. An E-brake control module provides controls for inducing the emergency braking of a UGV. A fail-safe control module provides controls for inducing the fail-safe state of a UGV. Configurable states such as enable/disable, run/pause, and other states may be defined. A speed control module provides a means for controlling the speed of a UGV. This configurable module may be defined to contain a drive control module and brake control module, to which discrete commands are dispatched for controlling the UGV's speed. Finally, a pluggable software control module provides a generic interface for triggering an action, triggering an action given a digital input value, triggering an action given an analog input value, or triggering an action given by one or more command values over a communications interface. The pluggable control can thus be extended and used to implement auxiliary controls on a UGV platform (e.g. trigger turn signals or lights).

Further extending the ground-based mobility module, a skid steer software control module may be configured for a ground-based mobility module. The skid steer module encapsulates a more specialized UGV mobility platform which performs its functions via skid steering of a robot. Thus, a port side and starboard side concept is embodied in the skid steer module. Drive control, steering control, brake control, and direction control modules embody control of port side and starboard side motor configurations to realize skid steering mobility controls.

Further extending the ground-based mobility module, a standard 4WD software control module may be configured for a ground-based mobility module. The standard 4WD module encapsulates a more specialized UGV mobility platform which performs its functions via control of a 4WD system. Thus, the concept of four-wheel independent drive is embodied in the standard 4WD module. Drive control, steering control, brake control, and direction control modules embody control of motors for the independent 4WD system. Similarly, a standard 2WD module may also be configured for the ground-based mobility module.

Further extending the ground-based mobility module, an Ackerman mobility software control module may be configured for a ground-based mobility module. The Ackerman mobility module encapsulates a more specialized UGV mobility platform which performs its functions via control of a 4WD system but with Ackerman style steering of one pair of the wheels. Thus, the concept of Ackerman steering of one pair of the four wheels and four-wheel independent drive is embodied in the Ackerman mobility module. Drive control, throttle control (in a gas-operated vehicle), steering control, brake control, and direction control modules embody control of motors for steering and the independent 4WD system.

Further extending the ground-based mobility module, standard NWD mobility software control module may be configured for a ground-based mobility module. The standard NWD mobility module encapsulates a more specialized UGV mobility platform which performs its functions via control of an N-WD system, that is a configurable set of N number of wheels. Thus, the concept of N-wheel independent drive (e.g. 6WD and 8WD) is embodied in standard NWD mobility module for the independent NWD system.

Further extending the ground-based mobility module, an omni-directional mobility software control module may be configured for a ground-based mobility module. The omni-directional mobility module encapsulates a more specialized UGV mobility platform which performs its functions via control of wheels which embody omnidirectional capability of the robot. Thus, a robot with omnidirectional wheels is embodied in the omni-directional mobility module. Drive control, throttle control (in a gas-operated vehicle), steering control, brake control, and direction control modules embody control of omnidirectional wheels on a robot.

Further extending the ground-based mobility module, a mechanum-wheel based mobility software control module may be configured for a ground-based mobility module. The mechanum-wheel based mobility module encapsulates a more specialized UGV mobility platform which performs its functions via control of mechanum wheels for omnidirectional capability of the robot. Thus, a robot with mechanum wheels is embodied in the mechanum-wheel based mobility module. Drive control, throttle control (in a gas-operated vehicle), steering control, brake control, and direction control modules embody control of mechanum wheels on a robot.

Further extending the ground-based mobility module, an automotive mobility software control module may be configured for a ground-based mobility module. The automotive mobility module encapsulates a more specialized UGV mobility platform which performs its functions via control of an automotive style platform. That is, a platform which has independently controlled speed, throttle and acceleration, braking, steering, transmission/gearing, and possibly E-braking. Thus, a robot with automotive style controls is embodied in the automotive mobility module. The drive control module is specifically configured to engage automotive speed/throttle/accelerator functions. The brake control module is specifically configured to engage automotive braking functions. The steering control module is specifically configured to engage automotive steering functions. The direction control module may be specifically configured to partially engage automotive functions of forward or reverse. The gear control module is specifically configured to engage automotive gear and transmission functions such as park, neutral, drive, low gear, and high gear. The E-brake control module is specifically configured to engage automotive E-braking functions.

A MAP base module is what provides the base upon which the weight and footprint of a payload may be mounted. Base modules also serve to connect with an underlying mobility module. A MAP base module interconnects with a MAP mobility module and/or other base modules. Base modules may be stacked or arranged in different configurations to provide the shape and base needed to support the payload for the MAP and separate the payload from the mobility module. Base modules may be solid or serve as containers inside which electronics equipment modules may be mounted.

A base module may also serve as a surface upon which a payload interface module is attached. Thus, the base module may bear the weight of the payload in a ground-based MAP or may simply have attachments, such as floats, to carry the payloads for other types of mobility applications. For example, a base module in an aerial-based or underwater-based MAP may simply have a camera attached to it. Base modules come in different sizes and serve as building blocks for creating composite bases. As an example configuration, for a ground-based MAP, a composite base module may be attached to a standard 4WD mobility platform beneath it, and have a payload interface module with a bench attached for a personal mobility application. Alternately, the same MAP base module and mobility module combination may be attached with a payload interface module connected to a container for carrying luggage in an airport luggage mobility application.

Because certain mobility modules may require different sized wheels for an application, the wheels may be larger than the mobility platform height. A single base module may be mounted in the center of the mobility platform but be wider than the wheelbase. Another base module may be added on the front and back of the center base module but on top of the mobility platform with a thinner width to sit between the larger wheels of the mobility platform. Additional base modules may then be added on top of the rear and forward mounted base modules, but wider to cover the tops of the wheels. The sizes and shapes of base modules may vary. However, standard means to interconnect base modules are defined to allow for interlocking and assembly of base modules to suit different autonomous applications and design needs.

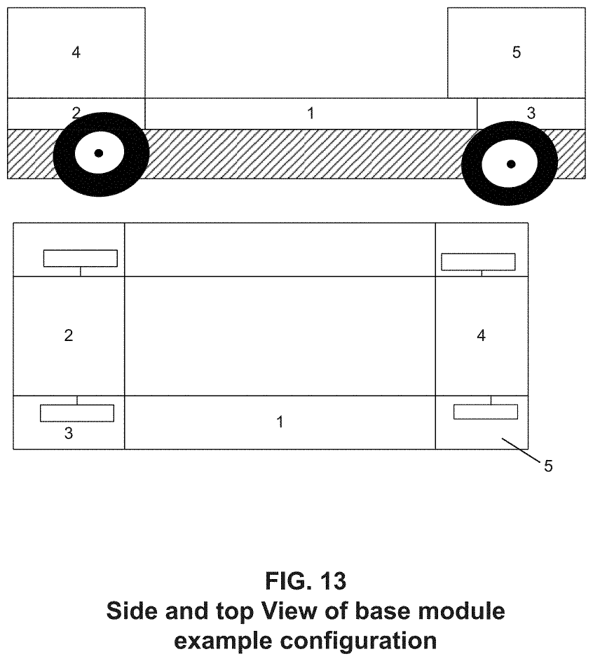

As an example, FIG. 13 shows a side view and a top view of a base module configuration atop a four-wheel drive ground mobility module. Base module 1 interlocks atop the mobility module and is wider than the wheelbase. Base modules 2 and 3 interlock in the rear and front respectively and are as wide as the mobility module. Base modules 4 and 5 interlock atop base modules 2 and 3 respectively and are as wide as base module 1. Payloads may be interlocked to base module 1 only, or perhaps to base modules 4 and 5 as well.

A MAP electronics equipment module is a module that contains and embodies any electronics equipment used for sensing and/or computation. Sensors for the MAPs detect physical world information as one would receive via cameras, global positioning system (GPS) sensors, LiDAR, RADAR, camera, ultrasonics, and other types of sensors. Computation equipment for the MAPs include micro-processor-based computers, embedded controllers, and other compute devices which calculate information, process information from sensors, formulate decisions and actions to take, and control the MAP. An electronics equipment module may be sized for the equipment it contains. A core electronics equipment module for a MAP is often contained within a MAP base module. This core electronics equipment module may contain a central computer and controller for the robotics control application. Cabling bundles from the core electronics equipment module may fan out to other electronics equipment modules distributed to attachment points on the MAP or its payload. These distributed electronics equipment modules may embody distributed sensors and/or computers for use in the specific MAP application.

A MAP payload cartridge interface module provides an interface with a payload to be attached to the MAP. Payload cartridge interface modules define a standard means for connecting payloads to a MAP. Different types of payload cartridge interface modules provide different types of mechanical and electrical interfaces as required for attaching payloads. Standard payload cartridge interface module options include:

1. General mechanical structures for bolting in payload components.

2. General mechanical structures for screwing in payload components.

3. General mechanical structures for latching or clamping in payload components.

4. General electrical harnesses for carrying power to or from payload components.

5. General electrical harnesses for carrying communication signals to/from payload components.

An inter-MAP interface module provides an interface for other MAPs to enable static or dynamic chaining and connection of MAPs to form larger composite MAPs. Inter-MAP interface modules define a standard means for connecting MAPs to one another. Different types of inter-MAP interface modules provide different types of mechanical and/or electrical interfaces for inter-connecting MAPs. Standard inter-MAP interface module options include:

1. General mechanical structures for connecting another MAP laterally, longitudinally, diagonally, or along any angular location relative to the current MAP. The angular

location may be fixed or adjusted mechanically, from 0 to 360 degrees around the MAP.

2. General mechanical structures for connecting another MAP laterally, longitudinally, diagonally, or along any extension distance relative to the current MAP. The extension distance may be fixed or adjusted mechanically, from 0 representing the edge of the first MAP to any range of distances from the MAP.

3. General electrical harnesses for interconnecting power between MAPs.

4. General electrical harnesses for interconnecting communications signals between MAPs.

5. General wireless communications for wireless communication between MAPs. Wireless communications may include standard WiFi, Bluetooth, near-field communications (NFC), dedicated short-range communications (DSRC), or other wireless communications mechanisms that may be embodied in a MAP electronics equipment module.

It should also be noted that a MAP may be equipped with a range of other features making it suitable for operation in physical environments. Other equipment may include bumpers, the ability to raise or lower a MAP, stability controls, payloads that involving providing coverings and shelter for people or things being transported by one or more interconnected MAPs, manipulator arms as payloads, and other forms of equipment that may be required for specific applications. Depending on the configuration, the MAP will also have the ability to disable a wheel or wheels (or to allow a wheel or wheels to move freely without power) or to remove a wheel or wheels.

Operational Aspects

In configuring a MAP for a particular application, the following components are selected:

1. A mobility module.

2. A base module.

3. One or more electronics equipment modules.

4. One or more payload cartridge interface modules.

5. An optional inter-MAP interface module.

6. A payload for the application.

Once selected, the MAP control software is dynamically and deliberately configured to provide desired control and operation of the assembled MAP configuration.

Illustrative of the variations possible with the MAP, a configuration is defined here for a personal mobility autonomous shuttle:

1. A standard 4WD mobility module assembled for 1000 lbs. payload weight.

2. A core electronics equipment module with compute element and a GPS/inertial measurement unit (IMU) receiver that supports processing data from other included

electronics equipment modules.

3. An electronics equipment module with a 3D LiDAR unit.

4. An electronics equipment module with a GPS antenna.

5. An electronics equipment module with a wireless communications adapter.

6. A base module sized for 1000 lbs. payload weight with the core electronics equipment module inside.

7. A payload cartridge module attached to the base module with an equipment adaptor

(pole or rod) for attachment of the 3D LiDAR equipment module and the GPS antenna equipment module.

8. A payload cartridge module attached to the base module with a bench (payload) for

seating a person.

9. A person sitting in the bench.

The personal mobility autonomous shuttle may then be controlled or operated via control software operating in the computer to sense position from GPS, provide self-navigation based on mapped waypoints for travel, and detect and avoid obstacles from sensor data received from the 3D LiDAR. The person onboard is autonomously shuttled to a desired destination.

Another configuration possible with the MAP is defined here for an autonomous luggage transporter:

1. A standard 4WD mobility module assembled for 250 lbs. payload weight.

2. A core electronics equipment module with a compute element and a GPS/IMU receiver.

3. An electronics equipment module with a 3D LiDAR unit.

4. An electronics equipment module with a GPS antenna.

5. An electronics equipment module with a wireless communications adapter.

6. A base module sized for 250 lbs. payload weight with the core electronics equipment module inside.

7. A payload cartridge module attached to the base module with an equipment adaptor (pole or rod) for attachment of the 3D LiDAR equipment module and the GPS antenna equipment module.

8. A payload cartridge module attached to the base module with a luggage rack (payload) for carrying luggage.

9. Luggage in the luggage rack.

The autonomous luggage transporter may then be controlled or operated via control software operating in the computer to sense position from GPS, provide self-navigation based on mapped waypoints for travel, and detect and avoid obstacles from sensor data received from the 3D LiDAR. The luggage onboard is autonomously shuttled to a desired destination.

Under a variation possible with the MAP, a person at an airport parking lot is greeted by two MAPs at the person's car. A personal mobility autonomous shuttle dynamically links with an autonomous luggage transporter over wireless communications adapters embodied in each MAP described above. The person loads luggage into the luggage transporter and climbs onboard the personal mobility shuttle. The personal mobility autonomous shuttle takes over as the primary mover and the autonomous luggage transporter follows at a configured distance. Upon reaching a specified destination, the autonomous luggage transporter dynamically “unlinks” from the personal mobility transporter and autonomously navigates to a luggage check-in station at an airport. Meanwhile, the personal mobility transporter transports the person further inside the airport to a departure check-in terminal. At that point, the person gets off the personal mobility shuttle which then is autonomously routed back out to a parking lot to service another customer. Both the personal shuttle and autonomous shuttle are returned to a “pool” of similar devices and are thus able to be redeployed as required by a central control and scheduling mechanism.

Under another variation possible with the MAP, two people at an airport parking lot, an adult and a child, are greeted by three MAPs at their car. Two personal mobility autonomous shuttles are physically connected laterally. This physical connection between the two personal mobility shuttles forms a “two-seater” shuttle that feels more secure for the adult as the child is physically connected with him/her on the same tandem shuttle (versus a wireless and physically uncoupled link). One of shuttles is dynamically linked with an autonomous luggage transporter over the wireless communications adapters embodied in each MAP described above. The shuttles travel to the airport under a scenario similar to the one described above. However, in this case, the tandem two-seater shuttle transports two people. The luggage transporter operates as it did with the single shuttle scenario Upon delivery of the passengers, the shuttles unlink and are redeployed independently to their next tasks.

Under another variation possible with the MAP, an autonomous luggage transporter autonomously links itself to a chain of five autonomous luggage transporters traveling at an airport. The “train” of six autonomous luggage transporters head toward a destination. However, at one programmed point, three of the autonomous luggage transporters break away from the other three autonomous luggage transporters. One train of three transporters head to one gate at the airport, while the other train of three transporters head to another gate.

Another configuration possible with the MAP is defined here for an autonomous waiter:

1. A standard 4WD mobility module assembled for 100 lbs. payload weight.

2. A core electronics equipment module with a compute element.

3. An electronics equipment module with a camera unit.

4. A base module sized for 100 lbs. payload weight with the core electronics equipment module inside.

5. A payload cartridge module attached to the base module with a mechanism for attachment of the camera equipment module.

6. A payload cartridge module attached to the base module with a shelving system

(payload) for carrying food and drinks.

7. Food and drinks on the shelving system.

The autonomous waiter may then be controlled or operated with control software operating in the computer to self-navigate in a restaurant using a camera for simultaneous location and mapping as well as obstacle detection and avoidance. The food and drinks onboard are autonomously transported to and from a kitchen to the correct tables in the restaurant as guided by a dining service application.

Another configuration possible with the MAP is defined here for an autonomous hauling system:

1. A standard 4WD mobility module assembled for 250 lbs. payload weight.

2. A core electronics equipment module with a compute element.

3. An electronics equipment module with a camera unit.

4. A base module sized for 250 lbs. payload weight with the core electronics equipment module inside.

5. A payload cartridge module attached to the base module with a mechanism for attachment of the camera equipment module.

6. A payload cartridge module attached to the base module with an open bucket container system (payload) for carrying things.

7. Trash cans, dirt, and other items stored in the bucket container.

The autonomous hauler may then be controlled or operated with control software operating in the computer to self-navigate outdoors at a property using a camera for simultaneous location and mapping as well as obstacle detection and avoidance. Trash cans are autonomously transported to and from a collection area to a garage at a house.

Under another variation possible with the MAP approach, another example configuration is defined here for an autonomous last-mile delivery robot:

1. A standard 2WD mobility module assembled for 250 lbs. payload weight.

2. A core electronics equipment module with a compute element and a GPS receiver.

3. An electronics equipment module with a LiDAR unit.

4. An electronics equipment module with a GPS antenna.

5. A base module sized for 250 lbs. payload weight with the core electronics equipment module inside.

6. A payload cartridge module attached to the base module with an equipment pole for attachment of the LiDAR unit and GPS antenna modules.

7. A payload cartridge module attached to the base module with an enclosed and lockable container system (payload) for carrying things.

8. Food, groceries, books, or other delivered goods in the container.

The autonomous last mile delivery robot may then be controlled or operated by control software operating in the computer to self-navigate outdoors in a suburban or urban community. Food, groceries, books, or other goods are delivered from a delivery truck at a parking lot, down a network of sidewalks, to the doorstep of a household in a community.

It should also be noted that a MAP is independent of its propulsion system. Thus, a MAP may be powered by batteries or gasoline by example. A battery-powered MAP to directly drive motors may be monitored for range and configured for autonomous re-charging. Similarly, a gas-powered map may be monitored for fuel levels and configured for autonomous re-fueling.

Furthermore, the ability to gracefully degrade with one or more motors cutting out and allowing the other motors to power the system in a multi-motor system may be configured for a MAP. Thus, as an example, a 4WD MAP may degrade or simply be reconfigured to a 2WD MAP statically or dynamically.

MAPs may be autonomous, tele-operated, manually controlled, or controlled according to a hybrid autonomous and manual operation mode.

### GENERAL

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. As another example, a drive system may be described that may be an electric drive system or one with an internal combustion engine; use of one drive system should not be read to preclude another drive system. Further, embodiments (whether or not explicitly described herein) have significant utility to fields and applications beyond the examples described herein.

Embodiments have been described herein with the aid of functional building blocks (e.g., modules or cartridges) illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

What is claimed is:

1. A modular autonomous platform comprising:
a mobility module comprising a drive system, the mobility module configured to move the modular autonomous platform; and
a base module attached to the mobility module and comprising an interface configured to receive a payload and an interface configured to couple with another modular autonomous platform.
